(19) United States
(12) Patent Application Publication
(10) Pub. No.: US 2023/0321756 A1
(43) Pub. Date: Oct. 12, 2023

(54) SYSTEM AND METHOD FOR MANUFACTURING PROTRUDING FEATURES ON A SUBSTRATE

(71) Applicant: Ohio Gratings, Inc., Canton, OH (US)

(72) Inventor: Riley George Gankoski, Canal Fulton, OH (US)

(73) Assignee: Ohio Gratings, Inc., Canton, OH (US)

(21) Appl. No.: 17/716,219

(22) Filed: Apr. 8, 2022

(51) Int. Cl. B23K 26/342; B22F 10/28; B23K 26/06; B23K 26/08; B23K 37/04; B22F 12/50; B22F 10/62

(52) U.S. Cl. CPC B23K 26/342; B22F 10/28; B23K 26/0613; B23K 26/0853; B23K 37/0408; B22F 12/50; B22F 10/62; B22F 2999/00; B33Y 10/00

(57) ABSTRACT

A system and method forms protruding features on a surface of a substrate through the use of multiple laser beams. The protruding features collectively define an array that results in a non-slip feature or non-slip element/texture on the substrate for installation in slippery environments for safe passage and traversing by persons thereabove. The plurality or multiple laser beams are carried by a moveable platform coupled with a CNC machine having instructions or logic that is programmed to form the protruding features at precise locations on the substrate. The multiple laser beams are angled relative to a center axis, typically more than 10 degrees relative to vertical. When three lasers are used, each laser beam is directed to a sector around a beam impingement point where powder material has been deposited to be liquefied by the beams. The beams are in respective sectors relative to the beam impingement point.

### TECHNICAL FIELD

This present disclosure is directed to the production of non-skid or slip-resistant material and more particularly to a system and method of producing a slip-resistant substrate by deposition of raised features of a compatible or dissimilar materials at select locations on the substrate surface by using multiple high power radiant energy sources, such as a plurality of lasers, electron beams, plasma transfer arcs, infrared lamps or the like, and a substrate including the same thereon.

### BACKGROUND

In certain industrial settings there are many locations that are difficult or even hazardous for personnel and/or motorized vehicles to move across due to materials that may coat the floor. Such materials include water mud, snow, blood, inks, oil, chemicals, and other slippery substances. If no precautions are taken, slips and falls may occur to personnel that can lead to costly injuries.

In order to reduce the chances of slips and falls, many propose to alter the surfaces to increase traction (or the coefficient of friction) in areas where accidents are most likely to occur. There are a number of known methods to alter the surface characteristics to increase the traction including using stamped or rolled materials, flame sprayed aluminum coatings, hot rolled materials, and grit bearing paints or tapes. All of these materials increase traction by populating the surface with aspirates which increase the frictional forces.

The use of laser or other high energy carrying radiation beams in metallic coating of a metallic substrate for repairing or improving wear resistance, or surface hardening of a metallic article is known and disclosed in U.S. Pat. No. 8,076,607 (the '607 patent), which is co-owned by Applicant of the present disclosure at the time of filing, and incorporated herein as if fully rewritten.

The '607 patent provides for the depositing of a material on a metallic substrate in a manner to create a non-skid surface that deposits an amount of powder material at specific locations on a substrate to create bead-like features that protrude a sufficient distance from the surface to increase the coefficient of friction, even when the surface is coated with a thin liquid film, such as oil. Additionally, the slip-resistant features were bonded with the substrate to prevent their being easily dislodged when subjected to lateral forces such as those occurring which objects are slid across the surface features. Creating bonds with sufficient strength required a sufficiently powerful energy or radiation source, one that creates a fusion zone between the slip-resistant features and substrate material that extends further into the substrate than conventional laser-cladding deposition methods.

The radiation source was either a laser, electron beam, or other infrared source mounted on a two-dimension movable positioning apparatus that allows the beam to be displaced in a direction at a predetermined speed relative to the substrate while maintaining the separation between the energy source and the substrate surface generally constant. The Radiation source included a beam adjustment apparatus that enabled the beam to be focused on a beam impingement point on the surface. Once focused, the movable positioning apparatus maintained the spacing between the source and the surface generally constant so that the beam remained focused on the substrate surface.

The '607 patent provided an apparatus including a high power radiant energy source or laser mounted generally vertically above a work-piece or substrate so that its focused beam is generally perpendicular to the surface of the substrate at the point of impingement. An energy source is positioned so that beam is angled no more than about ten degrees from an axis perpendicular to the substrate surface. The apparatus taught in the '607 patent, self-admittedly, provided that best performance was obtained when its energy source was positioned vertically above the surface of substrate when its beam is projected downwardly.

One specific embodiment of the '607 patent provides an energy source that is preferably positioned so that the beam is no more than 10 degrees from an axis perpendicular to the surface of the work piece or substrate. The '607 patent indicates that the best performance of its invention is obtained when the energy source is positioned vertically above the surface of the substrate such that the beam is projected downwardly. See '607 patent at Col.4:31-39. There is one powder feed mechanism adjacent to the radiation source for delivering powder material from a supply to the general area surrounding the beam impingement point. The powder feed mechanism includes a powder feed tube that has an end portion directed towards the substrate surface proximate to the beam impingement point at an angle of between approximately 25 and 80 degrees from horizontal. See '607 patent at Col.4:60-67. The upper end of feed tube is connected to a chamber that receives particle powder from source. The powder is gravity fed or otherwise caused to move through the powder feed tube into the energy beam where it interacted with the energy beam and substrate to form a plurality of the desired protruding, bead-like features. See '607 patent at Col.5:2-6.

### SUMMARY

Control of the apparatus of the '607 patent was believed to have been simplified compared to other known methods to enable greater material deposition rates thereby making the process commercially practical. However, the Applicant (which is the current owner of the '607 patent by way of Assignment) has determined that there is room for improvement. Namely, the use of a single laser beam to liquefy the powder material that has been deposited has been determined to be time consuming and utilize more powder than is necessary, and thus more efficient manners can be achieved. Additionally, more precise movement for the placement of the deposited material can be achieved. To address these and other issues, the present disclosure provides for an improved system and method that utilizes a plurality of energy sources that generate radiation, such as laser beams, that are carried and moved in a unique manner to allow for more efficient deposition of material on the substrate. Some embodiments use three feeds, which may be feed tubes or open feeds (such as a slide), to deliver less powder material that is still able to achieve a non-slip or protruding feature that results in similar size and composition that was previously achievable.

In one aspect, an exemplary embodiment of the present disclosure may provide a system to generate a protruding feature on a surface, the system comprising: a computer numerical code machine or assembly comprising a support surface defining a longitudinal direction, a transverse direction, and a vertical direction; a moveable platform that is offset from the support surface, wherein the platform is moveable relative to the support surface in the longitudinal direction and in the transverse direction in response to instructions processed by the computer numerical code machine or assembly; a plurality of radiation sources carried by the moveable platform, wherein each of the plurality of radiation sources generates an energy beam emitted from a radiation outlet, wherein the plurality of radiation sources comprises a first radiation source generating a first beam emitted through a first radiation outlet and a second radiation source generating a second beam emitted through a second radiation outlet; a first powder material source; and a first feed or feed tube in fluid or particle-flow or rheological communication with the first powder material source to discharge first powder material fed from the first powder material source, wherein the first powder material is configured to be energized by the first beam that is adapted to result in a protruding feature being formed on a surface of a substrate. This exemplary embodiment or another exemplary embodiment may further provide a second powder material source; and a second feed or feed tube in fluid or particle-flow or rheological communication with the second powder material source to discharge second powder material fed from the second powder material source, wherein the second powder material from the second power material source is configured to be energized by the second beam. This exemplary embodiment or another exemplary embodiment may further provide a third radiation source generating a third beam emitted through a third radiation outlet; and a third powder material source; a third feed or feed tube in fluid or particle-flow or rheological communication with the third powder material source to discharge third powder material fed from the third powder material source, wherein the third powder material from the third powder material source is configured to be energized by the third beam. This exemplary embodiment or another exemplary embodiment may further provide a center axis; a first sector bound by a first central angle of 120° relative to the center axis; a second sector bound by a second central angle of 120° relative to the center axis; and a third sector bound by a third central angle of 120° relative to the center axis. This exemplary embodiment or another exemplary embodiment may further provide wherein the first powder material from the first powder material source is deposited into the first sector after exiting the first feed or feed tube; wherein the second powder material from the second powder material source is deposited into the second sector after exiting the second feed or feed tube; and wherein the third powder material from the third powder material source is deposited into the third sector after exiting the third feed or feed tube. This exemplary embodiment or another exemplary embodiment may further provide a center axis of the moveable platform; wherein the first radiation outlet, second radiation outlet, and third radiation outlet are evenly spaced 120° from each other around to the center axis. This exemplary embodiment or another exemplary embodiment may further provide a first axis extending centrally through the first radiation source; and a first angle defined between the center axis and the first axis of the first radiation source, wherein the first angle is greater than 10°. This exemplary embodiment or another exemplary embodiment may further provide a second axis extending centrally through the second radiation source; a second angle defined between the center axis and the second axis of the second radiation source, wherein the second angle is greater than 10°. This exemplary embodiment or another exemplary embodiment may further provide a third axis extending centrally through the third radiation source; a third angle defined between the center axis and the third axis of the third radiation source, wherein the third angle is greater than 10°. This exemplary embodiment or another exemplary embodiment may further provide wherein the first angle is in range from about 15° to about 450; wherein the second angle is in range from about 15° to about 45°; and wherein the third angle is in range from about 15° to about 45°. This exemplary embodiment or another exemplary embodiment may further provide wherein the first angle is 20°; wherein the second angle is 20°; and wherein the third angle is 20°.

This exemplary embodiment or another exemplary embodiment may further provide wherein each radiation outlet of the plurality of radiation sources is moveable in conjunction with the moveable platform. This exemplary embodiment or another exemplary embodiment may further provide a vertical dimension between the moveable platform and the support surface that is variable by movement of at least one of the support surface and the moveable platform in the vertical direction

This exemplary embodiment or another exemplary embodiment may further provide a substrate having first and second ends aligned in the longitudinal direction, and having first and second sides aligned in the transverse direction, and having a first surface and a second surface aligned in the vertical therebetween, wherein the protruding feature is formed on the first surface of the substrate to create one of a plurality of protruding features that collective form an array of non-slip elements on the substrate.

In another aspect, an exemplar embodiment of the present disclosure may provide a method comprising: depositing powder material at a beam impingement point on a surface of a substrate; activating a plurality of radiation sources; generating at least one beam of radiation at each of the plurality of radiation sources; radiating at least one beam outward from each radiation source, wherein the at least one beam is part of a plurality of radiation beams; directing the plurality of radiation beams towards the beam impingement point on the substrate, wherein the plurality of radiation beams energize the powder material; liquefying the powder material at the beam impingement point with the plurality of radiation beams; ceasing the radiating of the plurality of radiation beams; and allowing the liquefied powder material to cool to form a protruding feature on the substrate. This exemplary embodiment or another exemplary embodiment may further provide determine, via input, a presence of the substrate on a support surface of a computer numerical code machine or assembly; moving a platform that carries the plurality of radiation sources in at least one of a longitudinal direction and transverse direction; and determine a bounded region of the substrate within which the protruding features will be formed.

This exemplary embodiment or another exemplary embodiment may further provide subsequent to the protruding feature having been formed, moving the platform that carries the plurality of radiation sources in at least one of a longitudinal direction and transverse direction to a second location relative to the substrate; forming a second protruding feature. This exemplary embodiment or another exemplary embodiment may further provide metering powder material through a plurality of feeds or feed tubes, each feed or feed tube in fluid or particle-flow or rheological communication with a powder material source. This exemplary embodiment or another exemplary embodiment may further provide generating a first radiation beam and directing the first radiation beam to a first sector bound by a first central angle of 120° relative to a center axis extending vertically through the beam impingement point; generating a second radiation beam and directing the second radiation beam to a second sector bound by a second central angle of 120° relative to the center axis; and generating a third radiation beam and directing the third radiation beam to a third sector bound by a third central angle of 120° relative to the center axis. This exemplary embodiment or another exemplary embodiment may further provide orienting a first radiation source along a first axis; and defining a first angle between a vertical center axis and the first axis of the first radiation source, wherein the first angle is greater than 10°.

In yet another aspect, an exemplary embodiment of the present disclosure may provide at least one computer readable non-transitory computer readable storage medium having instructions encoded thereon that, when executed by a processor, implement operations to form a protruding feature on a surface of a substrate, the instructions including: deposit powder material at a beam impingement point on the surface of the substrate; activate a plurality of radiation sources; generate at least one beam of radiation at each of the plurality of radiation sources; radiate at least one beam outward from each radiation source, wherein the at least one beam is part of a plurality of radiation beams; direct the plurality of radiation beams towards the beam impingement point on the substrate, wherein the plurality of radiation beams are operable to energize the powder material; confirm that the powder material at the beam impingement point with the plurality of radiation beams has been liquefied; cease the radiating of the plurality of radiation beams after the powder material has liquefied; and effect the liquefied powder material to cool to form the protruding feature on the substrate.

In yet another aspect, an exemplary embodiment of the present disclosure provide a system and method forms protruding features on a surface of a substrate through the use of multiple laser beams. The protruding features collectively define an array that results in a non-slip feature or non-slip element/texture on the substrate for installation in slippery environments for safe passage and traversing by persons there above. The plurality or multiple laser beams are carried by a moveable platform coupled with a CNC machine having instructions or logic that is programmed to form the protruding features at precise locations on the substrate. The multiple laser beams are angled relative to a center axis, typically more than 10 degrees relative to vertical. When three lasers are used, each laser beam is directed to a sector around a beam impingement point where powder material has been deposited to be liquefied by the beams. The beams are in respective sectors relative to the beam impingement point

### BRIEF DESCRIPTION OF THE SEVERAL VIEWS OF THE DRAWINGS

Sample embodiments of the present disclosure are set forth in the following description are shown in the drawings and are particularly and distinctly pointed out and set forth in the appended claims.

FIG. 1 (FIG. 1) is a top plan view of an exemplary CNC machine carrying a plurality of radiation sources to form a non-slip or protruding feature on a substrate according to one embodiment of the present disclosure.

FIG. 2A (FIG. 2A) is an isometric perspective view of a first embodiment of a platform assembly that carries the plurality of radiation sources.

FIG. 2B (FIG. 2B) is a side elevation view of the first embodiment of the platform assembly taken along line 2B-2B in FIG. 2A.

FIG. 2C (FIG. 2C) is a horizontal cross section view of the first platform assembly taken along line 2C-2C in FIG. 2B.

FIG. 3A (FIG. 3A) is an isometric perspective view of a second embodiment of a platform assembly that carries the plurality of radiation sources.

FIG. 3B (FIG. 3B) is a side elevation view of the second embodiment of the platform assembly taken along line 3B-3B in FIG. 3A.

FIG. 3C (FIG. 3C) is a horizontal cross section view of the first platform assembly taken along line 3C-3C in FIG. 3B.

FIG. 4 (FIG. 4) is an operational top plan view of the CNC machine having the first embodiment platform assembly connected thereto depicting a carriage positioned at a first location to form a first protruding feature.

FIG. 5A (FIG. 5A) is an operational top plan view of a plurality of feed tubes delivering powder material to a beam impingement point.

FIG. 5B (FIG. 5B) is a top plan view of a protruding feature having been formed on the surface of a substrate.

FIG. 6A (FIG. 6A) is an operational top plan view of a single of feed tube delivering powder material to a beam impingement point.

FIG. 6B (FIG. 6B) is a top plan view of a protruding feature having been formed on the surface of a substrate.

FIG. 7 (FIG. 7) is a cross sectional view of the protruding feature formed on the substrate taken along line 7-7 in FIG. 5B or FIG. 6B.

FIG. 8 (FIG. 8) is an operational top plan view of the CNC machine having the first embodiment platform assembly connected thereto depicting a carriage having been move through a plurality of different positions to form a plurality of distinct and separate protruding features on the substrate.

Similar numbers refer to similar parts throughout the drawings.

### DETAILED DESCRIPTION

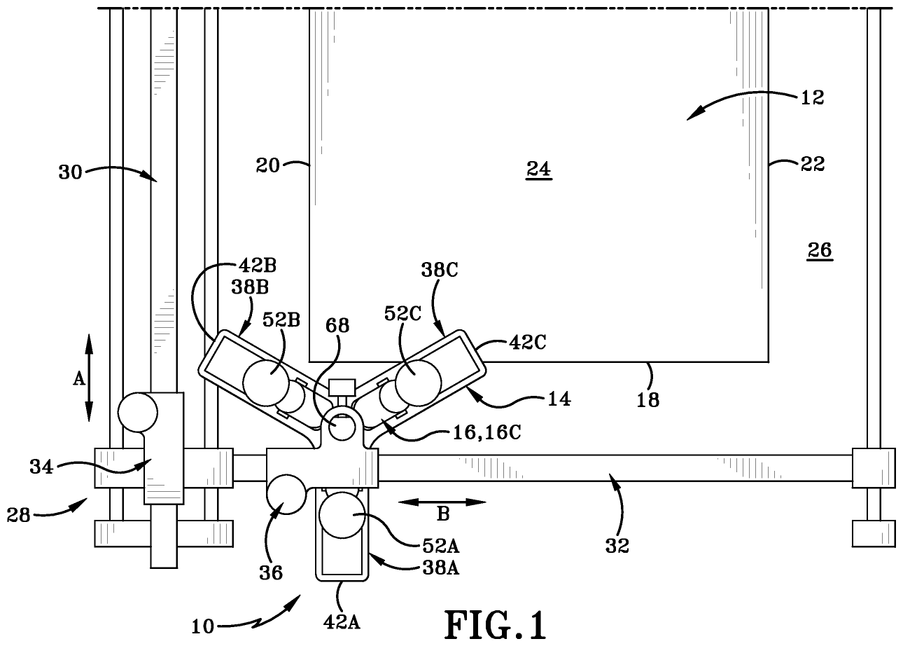

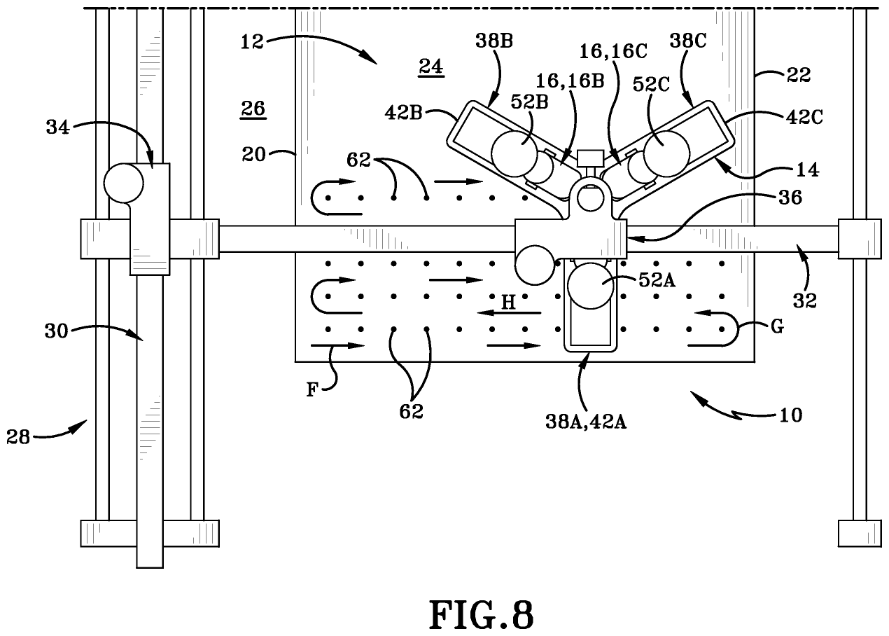

FIG. 1 generally depicts a system to generate or manufacture a non-slip feature or slip-resistant coating or protruding feature on a surface of a substrate generally at 10. System 10 includes a substrate 12, a movable platform 14, and a plurality of radiation sources 16. The plurality of radiation sources 16 are carried by the movable platform 14 and can move in unison with platform 14 relative to the substrate 12 in order to form, generate, or manufacture the slip-resistant coatings or nonslip features (i.e., protruding feature(s) 62—FIG. 8) on the substrate 12 as detailed herein.

Substrate 12 includes a first end 18 opposite a second end (not shown) defining a longitudinal direction therebetween. Substrate 12 includes a first side 20 opposite a second side 22 defining a transverse direction therebetween. The transverse direction of the substrate 12 is perpendicular to the longitudinal direction of the substrate 12. Substrate 12 includes an upper or first surface 24 opposite a second or lower surface (not shown) defining a vertical direction therebetween, wherein the vertical direction is perpendicular to the longitudinal direction and the transverse direction. The protruding feature 62 (i.e., a nonslip feature or slip-resistant coating) is configured to be formed on one of the two surfaces of the substrate 12. In one particular embodiment, the protruding feature 62 is configured to be formed on the first or upper surface 24 of substrate 12.

FIG. 1 depicts that substrate 12 is supported by a support surface 26 that is part of a computer numerical control (CNC) machine or assembly 28. The CNC machine 28 has a first end opposite a second end aligned in the longitudinal direction, a first side opposite a second side aligned in the transverse direction, and a top opposite a bottom aligned in the vertical direction. The CNC machine 28 enables the platform 14 to be a motorized maneuverable tool that is movable or maneuverable relative to the substrate 12 and the support surface 26 according to specific logic or computer input instructions. The logic may include at least one nontransitory computer readable storage medium having instructions encoded thereon that, when executed by a processor, implement operations to form at least one protruding feature 62 on surface 24 of substrate 12 that results in the substrate to have non-slip or anti-slip properties for later installation on a floor or ground surface so that persons may traverse atop the substrate.

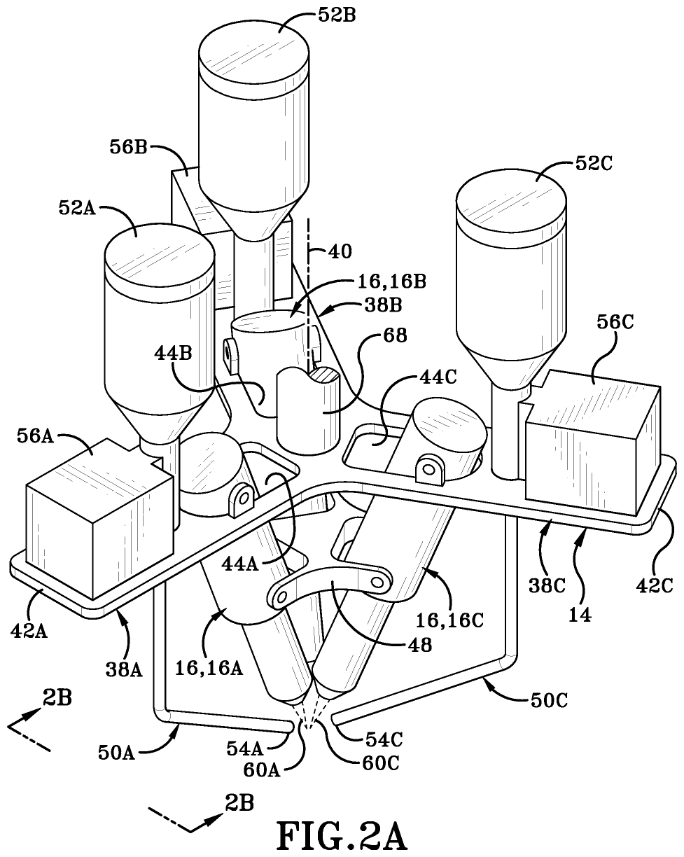

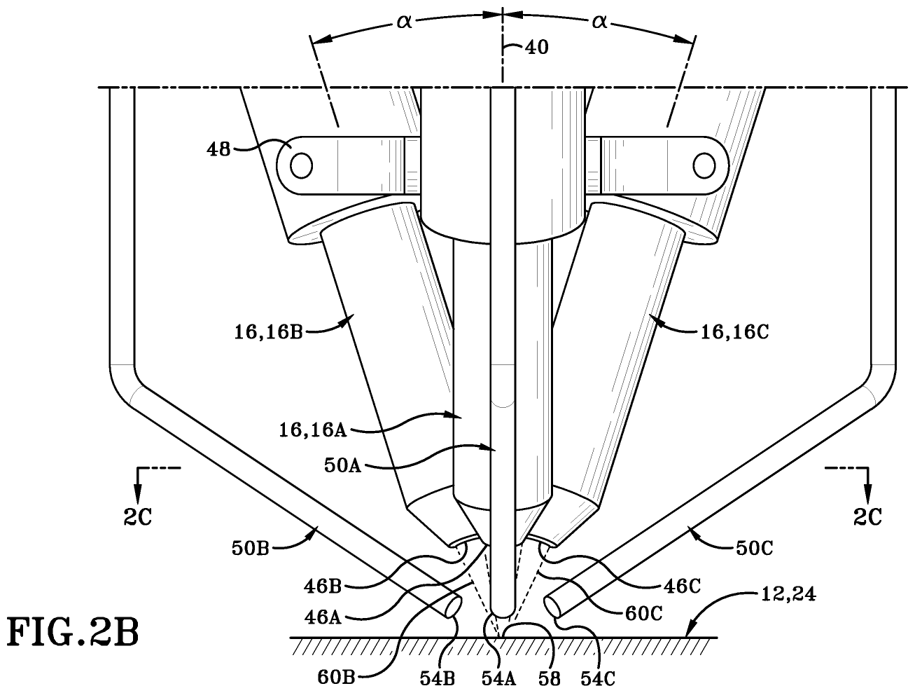

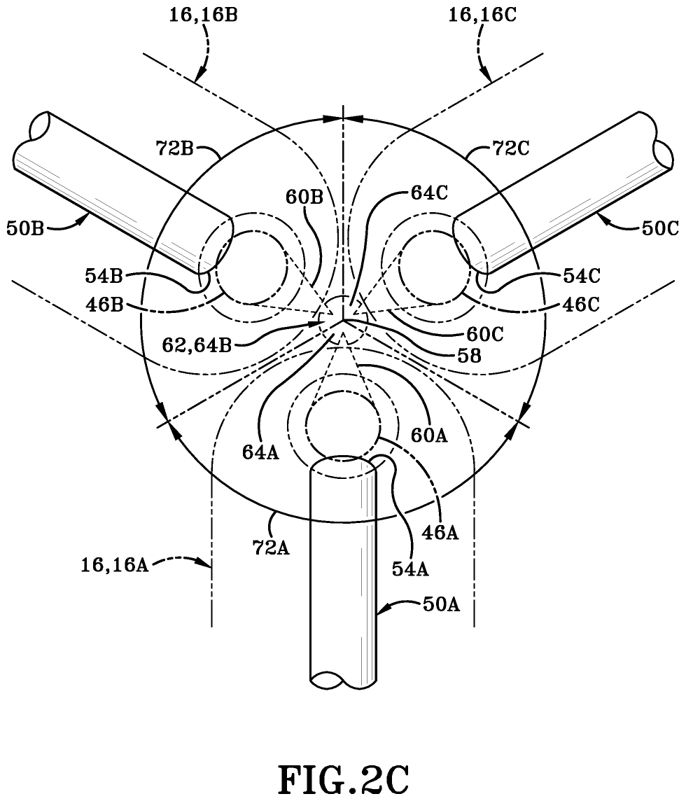

The CNC machine 28 may include a first rail 30 and a second rail 32. The first rail 30 is aligned in the longitudinal direction and the second rail 32 is aligned in the transverse direction. CNC machine 28 includes a carriage 34 that is configured to move along first rail 30 as indicated by arrow A. CNC machine 28 may additionally include a second carriage 36 that is configured to move along the second rail 32 in the transverse direction as indicated by arrow B. First carriage 34 and second carriage 36 may be powered by electrical motors as one having ordinary skill will recognize. Further, a vertical dimension between the substrate and the platform 14 may be varied in the vertical direction by movement of at least one of the substrate 12 and the movable platform 14 in the vertical direction. Towards this end, the CNC machine 28 may include a vertical rail (not shown) coupled with a motor that enables the platform 14 to be vertically raised and lowered relative to first surface 24. Alternatively, the CNC machine 28 may include an electrical motor that raises and lowers the support surface 26 in the vertical direction to vary the distance between the platform 14 and the substrate 12. Alternatively, there may be a motor coupled to or in operative communication with a center post or center bar 68 (FIG. 2A) of platform 14 that selectively moves the platform vertically up and vertically down relative to substrate 12.

FIG. 1 and FIG. 2A depict platform 14 as a generally rigid structure composed of three arms spaced approximately 120 degrees apart relative to a vertical center axis 40 configured to carry the plurality of radiation sources 16. However, it is to be understood that platform 14 may take alternative configurations capable of carrying or otherwise supporting the plurality of radiation sources 16. For example, platform 14 may be configured as a square plate or a circular plate having a plurality of radiation sources 16 attached thereon. Additionally, when platform 14 is embodied as a three-armed structure, the arms to do not need to necessarily be spaced equidistant or equal-angle relative to the vertical center axis or equal-angle relative to each other.

When the platform 14 is configured as shown throughout the figures, the platform 14 may include a first arm 38A, a second arm 38B, and a third arm 38C. First arm 38A extends radially outward from a center axis 40 to a radial end 42A, wherein center axis 40 is aligned in the vertical direction through center bar 68. Second arm 38B extends radially outward from center axis 40 to radial end 42B. Third arm 38C extends radially outward to radial end 42C from center axis 40. In one particular embodiment, the radial ends 42A, 42B, and 42C lie along a common imaginary circumference having an equal radius from center axis 40 relative to each other. However, it is entirely possible for the radial ends 42A, 42B, and 42C to have different radiuses relative to center axis 40.

First arm 38A defines a first aperture 44A, the second arm 38B defines a second aperture 44B, and the third arm 38C defines a third aperture 44C.

A first radiation source 16A extends through the first aperture 44A in first arm 38A. A second radiation source 16B extends through the second aperture 44B in second arm 38B. A third radiation source 16C extends through the third aperture 44C in third arm 38C. In one particular embodiment, each of the radiation sources 16A-16C may be fixedly mounted to each respective arm 38A-38C such that the plurality of radiation sources 16 do not move relative to their respective apertures. However, in an alternative embodiment, it is possible for the apertures 44A, 44B, and 44C to be formed as an oval (or otherwise as an elongated slot) such that a portion of the respective radiation sources 16A, 16B, and 16C may slide or otherwise may move along a radial length of each respective arm of platform 14. The movement of radiation sources 16A, 16B, and 16C may be effectuated by sliding movement or other movement that otherwise translates a portion of each respective radiation source 16A, 16B, and 16C in the radial direction relative to center axis 40 along the length of each respective arm 38A, 38B, and 38C.

Each radiation source has a radiation outlet. More particularly, the first radiation source 16A has a first radiation outlet 46A, the second radiation source 16B has a radiation outlet 46B, and the third radiation source 16C has a radiation outlet 46C. The radiation outlets are directed and pointed towards the surface 24 of substrate 12. Inasmuch as the radiation outlets 46A, 46B, and 46C are carried by their respective radiation sources, the radiation outlets move in conjunction with the platform 14 as it is moved in the longitudinal direction and the transverse direction by CNC machine 28.

The plurality of radiation sources may include other hardware to fixedly connect or movably connect the radiation sources 16A, 16B, and 16C to platform 14. For example, there may be an intermediate bracket 48 that is positioned below plate 14 that couples to each of the radiation sources 16. The intermediate bracket 48 may fixedly connect the radiation sources 16 in a fixed position when the application-specific embodiment desires such a relationship, or alternatively, the intermediate bracket 48 may allow for pivoting or sliding movement of the radiation sources 16 if so desired.

FIG. 2A depicts an embodiment of system 10 in which each radiation source 16A, 16B, and 16C has its own dedicated feed supplying powder material from an independent powder source. The feeds may be generally shown as tubes. However, it is to be understood that the term feed also refers to a structure that conveys powder material and is not limited to a structure with a completely bound bor. For example, the feed may be a slide that is open to the environment rather than being a bound tube with power material 70 moving through the bore thereof.

One embodiment of system 10 has a first feed tube 50A is in fluid communication with a first powder source 52A. A second feed tube 50B is in fluid communication with a second powder source 52B. A third feed tube 50C is in fluid communication with a third powder source 52C. Each feed tube includes a lower end 54A, 54B, and 54C, respectively. The lower end 54A of first feed tube 50A is closely adjacent the first radiation outlet 46A. The second outlet 54B of second feed tube 50B is closely adjacent the second radiation outlet 46B. The third outlet 54C on third feed tube 50C is closely adjacent the third radiation outlet 46C. The powder material contained in each of the respective powder sources, which may be generally shaped as hoppers, may be fed by respective feeding mechanisms 56A, 56B, and 56C. Each of the respective feed tubes 50A, 50B, and 50C deliver powder material from their respective supply sources to the beam impingement point 58. The ends or outlets of each respective feed tube proximate the beam impingement point 58 may deliver the powder material outward from the end of each respective feed tube 50A-50C at an angle between 25 degrees and 80 degrees from horizontal or relative to surface 24 of substrate 12.

As depicted in FIG. 2B, when viewed in a side elevation view, each radiation source 16 is tilted at an angle α relative to vertical axis 40. Particularly, each radiation source has its own respective center axis that is tilted or angled at angle α relative to vertical center axis 40 (i.e., first radiation source 16A has a first axis, second radiation source 16B has a second axis, and third radiation source 16C has a third axis). For one exemplary embodiment, it has been determined that each radiation source should be tilted at an angle α relative to the vertical center axis that is greater than ten degrees. In one particular embodiment, the angle α is in a range from about 15 degrees to about 45 degrees relative to the vertical axis 40. Stated otherwise, each radiation source is angled greater than ten degrees from an axis perpendicular or normal to the substrate 12. In one particular embodiment, the angle α is more than 15 degrees relative to the vertical center axis. In another particular embodiment, each radiation source is angled at about 20 degrees from the vertical center axis 40 that is an axis perpendicular to the substrate 12. It has been determined that the use of multiple radiation sources or a plurality of radiation sources 16 offers better performance than using a single radiation source positioned vertically above the substrate projecting a beam downwardly. Thus, the use of three angled radiation sources may provide an improvement over that which has been previously known and utilized.

FIG. 2C depicts that the three radiation sources 16A, 16B, and 16C are directed toward the beam impingement point 58 that is formed by a first beam 60A, a second beam 60B, and a third beam 60C being directed towards impingement point 58. Each of these beams 60A, 60B, and 60C that are generated from the respective radiation outlets 46A, 46B, and 46C contact the powder material 70 flowing out of the ends or outlets 54A, 54B, and 54C, respectively, to transfer beam energy into the powder material (and melt or liquefy the powder material 70) to form a resultant bead-like deposit or protruding feature 62 that will be part of a collective array to result in a non-slip element on substrate 12.

The protruding feature 62 is formed at the beam impingement point 58 and is composed of three sectors. Namely, a first sector 64A defined by the first beam 60A energizing powder material, a second sector 64B defined by second beam 60B energizing powder material, and a third sector 64C defined by third beam 60C energizing powder material. In one particular embodiment, the three sectors 64A, 64B, and 64C have central angels that are of equal radians or degrees relative to the vertical center axis 40 that extends centrally through beam impingement point 58, namely, 120 degrees.

As depicted in FIG. 2C, the first sector 64A, the second sector 64B, and the third sector 64C of the protruding feature 62 define a halo pattern or generally circular profile or perimeter edge of the protruding feature 62. The halo deposition pattern of the material at the beam impingement point 58 is effectuated by material flowing outwardly from the respective feed tubes 50A-50C from three different and distinct points. Although each respective sector occupies approximately a 120 degree section or central angle of the circular circumference or perimeter of the protruding feature 62, it is to be understood that the sector angles may vary if the application-specific requirements desire or are needed in that manner. First sector 64A is shown as having an arc defined by a 120 degree center angle as represented by arc length 72A. Second sector 64B is shown as having an arc defined by a 120 degree center angle as represented by arc length 72B. Third sector 64C is shown as having an arc defined by a 120 degree center angle as represented by arc length 72C.

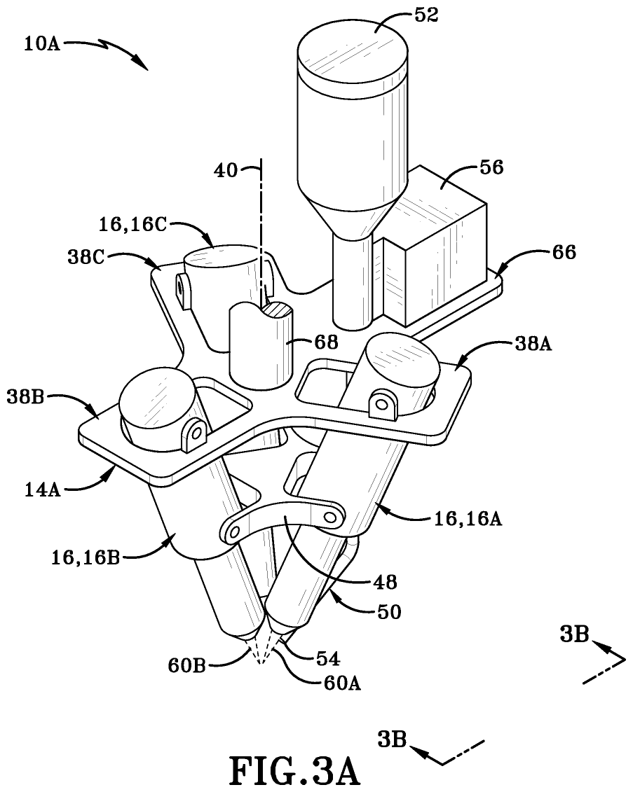

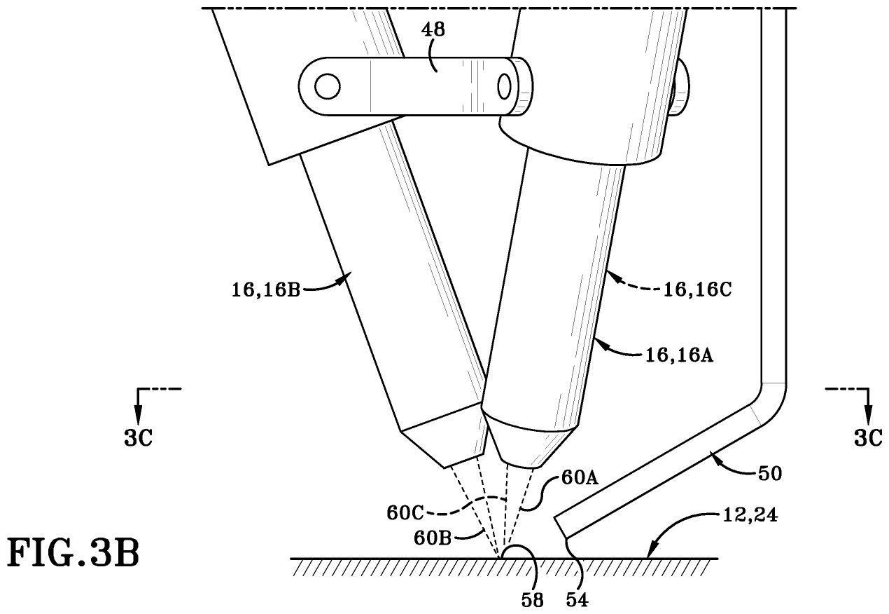

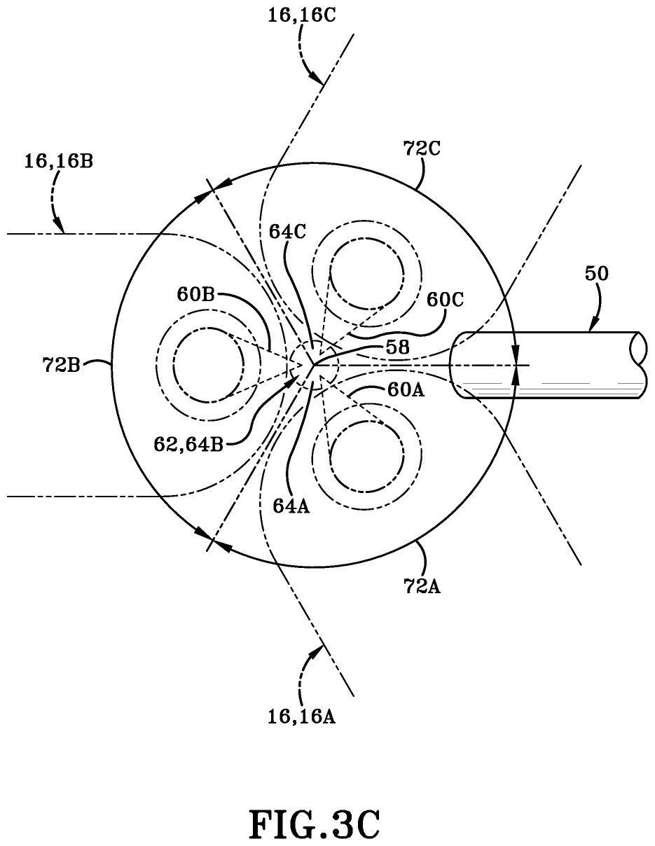

FIG. 3A, FIG. 3B, and FIG. 3C depict an alternative embodiment of a system to generate a non-slip feature on a surface generally at 10A. System 10A differs from system 10 inasmuch as it includes only a single material source or powder source 52 fluidly connected with a feed tube 50 having an end 54 to discharge powder material towards the beam impingement point 58. System 10A includes a feed mechanism 56 carried by a platform 14A that includes a projection or fourth arm 66 to support the feed mechanism 56 thereon. The projection 66 is a support surface integral with platform 14 that is located between first arm 38A and third arm 38C.

FIG. 3A depicts that the platform 14A may be coupled to the second carriage 36 in a similar manner as platform 14 through the use of a central connecting rod or bar 68 that extends coaxially along the vertical center axis 40.

FIG. 3C depicts system 10A in which the single feed tube 50 and its lower end 54 is configured to discharge powder material towards the beam impingement point 58. Inasmuch as system 10A still utilizes a plurality of radiation sources 16, namely, first radiation source 16A, second radiation source 16B, and third radiation source 16C, each of these respective beams will energize the powder material in their respective sectors 64A, 64B, and 64C to liquefy the powder material to form the protruding feature 62. Although there is only a single feed tube 50A in the embodiment of system 10A, the sectors 64A, 64B, and 64C all occupy approximately 120 degrees relative to the vertical axis 40.

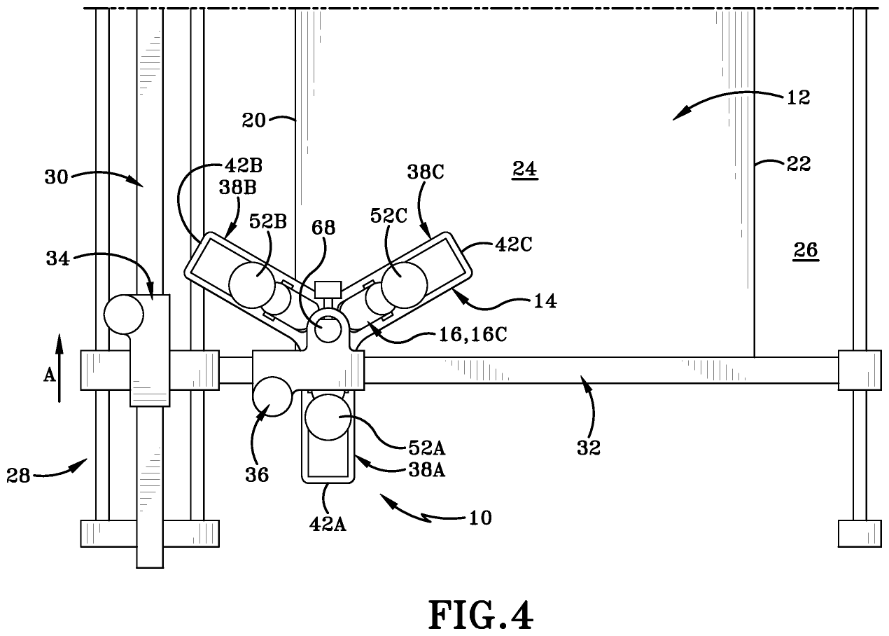

FIG. 4 depicts an operational embodiment of system 10 in which the CNC machine 28 is operatively moving the plurality of radiation sources 16 to a desired location above substrate 12 in order to deposit and ultimately create the protruding feature 62 on surface 24. The CNC machine uses computer logic or other instructions to determine where an operator desires to have the beams 60A-60C energize the powder material 70 in order to form the protruding feature 62 on surface 24. The CNC instructions move the first carriage 34 and the second carriage 36 in the respective longitudinal and transverse directions to appropriately position the beam impingement point 58 at a desired location on surface 24. FIG. 4 depicts the operative movement of the first carriage 34 being moved longitudinally in the direction of arrow A that aligns the heads of the radiation sources 16A-16C adjacent the first end 18 and the first side 20 of substrate 12. Similar movement operations would occur for platform 14A carrying only a single feed tub and powder material source.

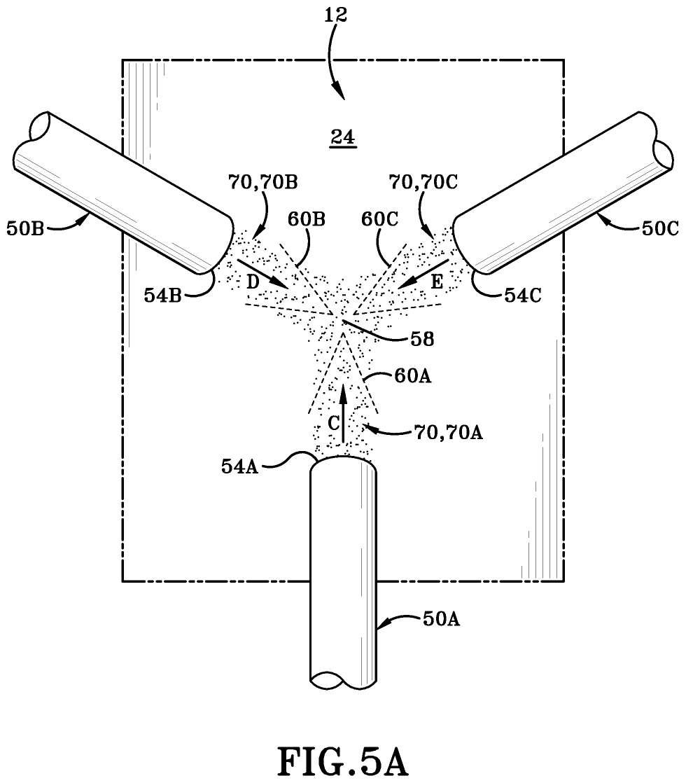

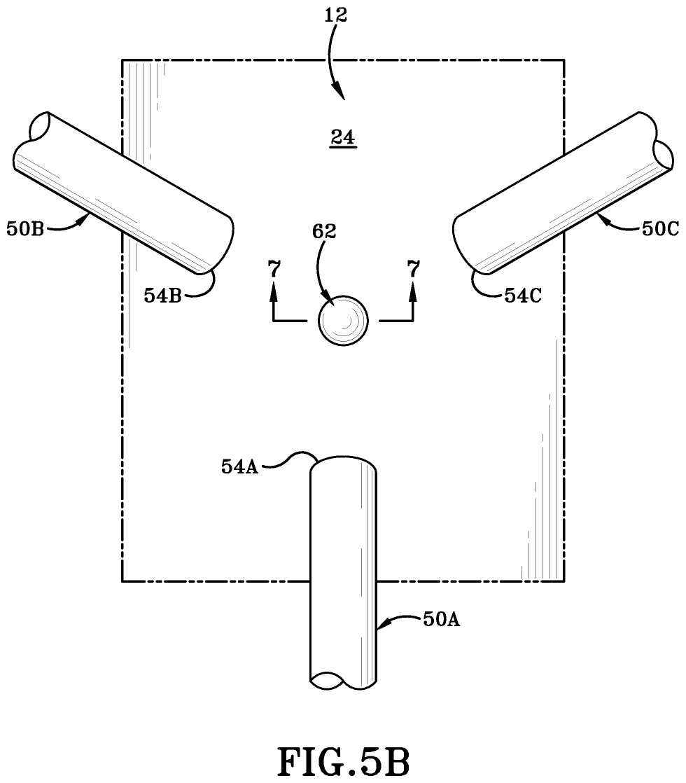

FIG. 5A depicts the depositing of powder material 70 from the respective feed tubes 50A-50C in system 10. More particularly, a first portion 70A of powder material 70 flows out of first feed tube 50A through lower end 54A as indicated by arrow C. A second portion 70B of powder material 70 flows out of second feed tube 50B through the lower end 54B as indicated by arrow D. A third portion 70C of powder material 70 flows through third feed tube 50C through lower end 54C as indicated by arrow E. Each of the portions 70A-70C of powder material 70 are directed towards the beam impingement point 58. The first beam 60A energizes the first portion 70A of powder material 70 to melt/liquefy or otherwise energize first portion 70A to create the first sector 64A of the protruding feature 62. Second beam 60B energizes or otherwise melts/liquefies the second portion 70B of powder material 70 to create the second sector 64B of protruding feature 62. The third beam 60C energizes, melts, or liquefies the third portion 70C of powder material 70 to create the third sector 64C of the protruding feature 62. FIG. 5B depicts the resultant protruding feature 62 formed on surface 24 of substrate 12.

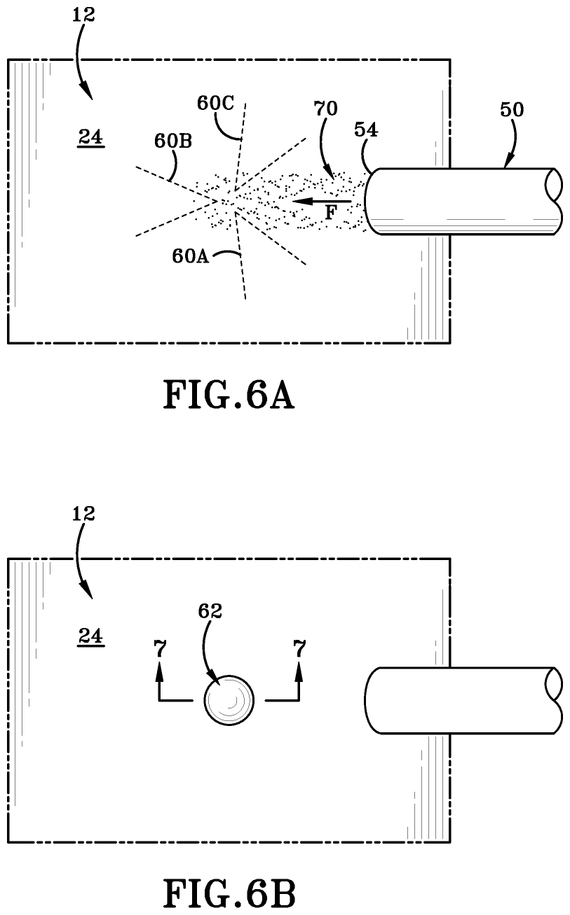

FIG. 6A and FIG. 6B depict the operational embodiment of system 10A in which a single feed tube feeds powder material 70 outwardly through the lower end 54 of feed tube 50 as indicated by arrow F. The three beams 60A, 60B, and 60C collectively energize or melt the powder material 70 to create the resultant protruding feature 62 on the surface 24 of substrate 12.

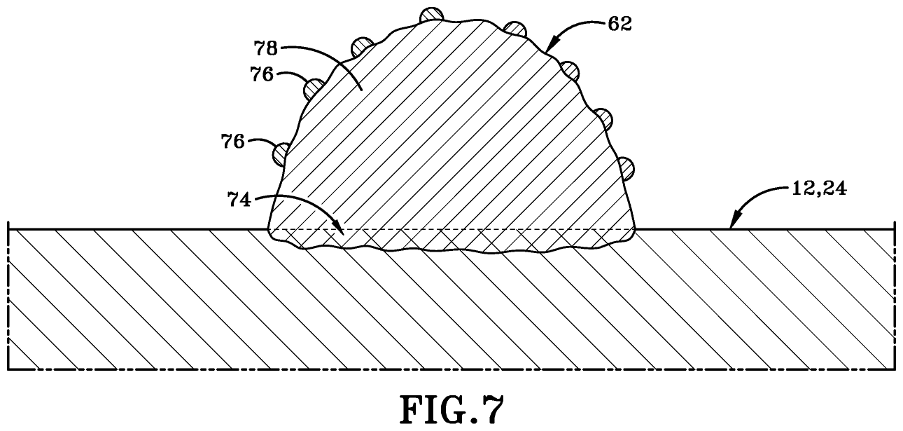

FIG. 7 depicts a cross section view of substrate 12 and a protruding feature 62 extending from the surface 24 of the substrate 12 at approximately the apex or midsection of feature 62. The protruding features 62 are formed on the substrate 12 by the interaction of the three energy beam 60A, 60B, and 60C with the substrate 12 and the presence of the powder material 70, which may be fed from three independent sources 52A, 52B, and 52C at the impingement point 58. The feature size and spacing is mainly dependent on the laser power of each of the plurality of lasers/radiation sources, volume or amount of powder material 70 (which is less than the amount of power material that would be needed to form an identical protruding feature 62 using only a single laser), soot size, beam(s) intermittence (pulse width and duration), powder feed rate, powder type and the laser(s) or substrate travel speed. Variation of these parameters in the present disclosure provides the capability to control and vary the dimensional configuration of the protruding features 62 to provide the desired slip-resistance on the substrate 12. Adjustment of the beam spot size or the use of a different diameter laser fiber allows the width of the feature 62 in a direction normal to the direction of longitudinal direction of travel to be established and controlled. Ideally, the feature will have a length to width proportion as close as is achievable to one to produce anti-slip features that are not direction-specific, that is the coefficient of friction is generally the same regardless of the direction of movement across the substrate. It is also possible to operate the laser in a continuous mode as the laser traverses the substrate surface such that a linear ridge-like feature is produced.

The approach to control the size of feature 62 used by the present disclosure represents an improvement over known methods in which precise control of the relative positioning between a plurality of radiation sources 16 and substrate 12 and/or precision control of the powder material 70 is necessary to create the desired raised bead-like features using less powder material than was previously capable to form a protruding feature 62 of similar size using only a single radiation source or laser.

FIG. 7 depicts the configuration of the protruding feature 62 at the point of connection with substrate 12. Since protruding feature 62 is connected to substrate 12 using a process that takes both the powder material 70 and the substrate 12 material into a partially molten state and forms a fusion zone 74 comprising substrate and powder material, there is little tendency for the molten powder to take a drop-like form sitting atop the substrate at the impingement point 58. Instead, protruding feature 62 forms with the substrate surface 12 a side angle.

The characteristics of the features, in addition to the laser and speed variables mentioned above, depended largely on the types of powders and blends used for the features. For example, materials which are required to meet the minimum OSHA mandated coefficient of friction (COF) of 0.50 to be considered slip resistant were manufactured with features that used only the base alloy powders. To meet higher COF requirements, the type of alloy selected, the additives and their percentages were critical. There may be distribution of the additives 76 within the volume 78 of the protruding feature 62. As a natural function of the freezing or hardening process of the protruding feature 62 once the three energy beams 60A, 60B, and 60C are removed (cycled off), the insoluble particles of the additive 76 are “suspended” throughout the feature volume 78, including on the surface. Depending on the powder material 70 blend selected, COF's exceeding 1.0 can be maintained.

The perimeter shape of the protruding feature 62 may take any shape or profile to meet a variety of application specific needs. However, one particular embodiment of system 10 creates at least one protruding feature 62 with an ellipse-shaped perimeter rather than a simple circular-shaped perimeter. When at least one protruding feature 62 is formed with an ellipse-shaped perimeter it will have a length and a width that have different dimensions. The ellipse-shaped perimeter of at least one protruding feature 62 can have a length (measured through the apex of protruding feature 62) that is in a range from about 0.1″ to about 0.2″. In one particular embodiment, the length of the ellipse-shaped perimeter is in a range from 0.13″ to 0.18″. The ellipse-shaped perimeter of at least one protruding feature 62 can have a width (measured through the apex of protruding feature 62) that is in a range from about 0.05″ to about 0.1″. In one particular embodiment, the width of the ellipse-shaped perimeter is in a range from 0.06″ to 0.08″. When the protruding feature is formed with the ellipse-shaped perimeter, the protruding feature will have a height (measured from surface 24 of substrate 12 to the apex of the protruding feature). The height of the ellipse-shaped perimeter may be in a range from about 0.02″ to about 0.04″. In one particular embodiment, the height of the ellipse-shaped protruding feature 62 is in a range from 0.027″ to 0.032″. In another particular embodiment, the height of the ellipse-shaped protruding feature 62 is in a range from 0.03″ to 0.035″.

With respect to the dimensions of the ellipse-shaped protruding feature discussed herein, there may be criticality in the claimed ranges to accomplish the goal of creating a non-slip texture on the substrate 12. Particularly, the shape of the ellipse perimeter with these dimensions is effectuated by forming the protruding feature 62 with a plurality of radiation sources 16. For example, when two radiations sources are used, such as source 16A and 16B, which would be positioned 180° from each other (rather than 120° when three radiation sources are used), the opposing beam projections contact the beam impingement point 58. The powder material 70 melts or liquefies and creates the raised apex near the center, and the liquefied material 70 gradually spreads towards the perimeter and forms the ellipse-shaped perimeter upon cooling and hardening/freezing.

Having described one or more exemplary configurations of the present disclosure, reference is made to its operation for forming a non-slip coating or material (or deposits thereof) on a substrate.

FIG. 8 depicts the operational embodiment of the CNC machine 28 following a set of numerical instructions to deposit the plurality of bead-like protrusions or protruding feature 62 on surface 24 of substrate 12. FIG. 8 depicts an embodiment in which the CNC machine assembly 28 has directed the formation of protruding features 62 by first moving in the transverse direction from the first side 20 to the second side 22 as indicated by arrow F. Once the CNC machine reaches a destination adjacent the second side 22 of substrate 12, the machine may move first carriage 34 longitudinally as indicated by arrow G where the machine may then continue creating protruding features 62 and move the second carriage 36 transversely back towards the first side 20 as indicated by arrow H, which is opposite that of arrow F. This process may be repeated until the desired number of protruding features has been created on surface 24 of substrate 12.

The operation of system 10 depicted in FIG. 8 may be effectuated, accomplished, or otherwise implemented by logic in operative communication with the CNC machine or CNC assembly. The instructions on the CNC logic may first instruct one or more sensors, such as passive or active sensors on the CNC machine to detect the substrate 12 having been placed on support surface 26. The sensors may actively or passively measure the size of the substrate, or an operator may provide the dimensions of substrate to the CNC logic. Using the dimensions, the logic may determine the surface area or otherwise define a bounded region on surface 24 of substrate 12 that protruding features 62 will be formed. However, it is possible for the logic to determine the bounded region without the dimensions. Alternatively, an operator by proactively set a bounded region on surface 24 for the protruding features to be formed.

The instructions in the CNC logic may be executed by a processor to direct the formation of the plurality of bead-like protrusions or protruding feature 62 on surface 24 of substrate 12. The instructions first move the platform, by way of moving one or more carriages along the rails on the CNC machine assembly 28 to a first location above surface 24 on substrate. The instructions execute code to activate or otherwise “turn on” the plurality of radiation sources 16. Notably, the activation of radiation sources 16 may occur either before or after the carriage(s) have moved platform 14.

In the first embodiment, the instructions may direct the plurality of feed mechanisms to precisely meter powder material 70 or otherwise selectively open a valve (if present in feed mechanisms 56A-C) so powder material may be gravity fed through the three feed tubes towards the beam impingement point 58. In the second embodiment, the instruct the feed mechanism to precise meter powder material 70 or otherwise selectively open a valve (if present in the feed mechanisms 56) so powder material may be gravity fed through the three feed tubes towards the beam impingement point 58.

When powder material has been fed to the beam impingement point 58 atop surface 24, and the radiation sources 16A-16C are activated or otherwise “on”, the three beams 60A-60C may be generated. Notably, each radiation source may include one or more beam optics to direct each respective beam out of each radiation outlet 46A-46C. The beams 60A-60C exit radiation outlets 46A-46C, as indicated in FIG. 5A or FIG. 6A, to form the protruding feature 62, as shown in FIG. 5B or FIG. 6B, respectively.

With continued referenced to FIG. 8, once the first protruding feature 62 has been formed at the first location, the CNC instructions may then direct the moveable platform to a second location atop surface 24. Namely, the instructions will have been pre-loaded into CNC logic such that upon completion of the first protruding feature 62, the CNC logic will know which location is to be second location for forming a second protruding feature. The CNC logic will provide movement instructions to one or both motors on the first carriage 34 and/or second carriage 36 to effectuate movement thereof along the rails to thereby impart movement to platform 14 and radiation sources 16 in unison. The example of FIG. 8 has indicated that once the CNC machine reaches a destination adjacent the second side 22 of substrate 12 (i.e., the formed the last protruding feature in a row), then the CNC logic instructions direct the motors of carriages 34 or 36 to move first carriage 34 longitudinally as indicated by arrow G where the machine may then continue creating protruding features 62. The CNC instructions direct the movement of the second carriage 36 transversely back towards the first side 20 as indicated by arrow H, which is opposite that of arrow F.

Further, while the protruding features 62 have been shown as formed in an array, as separate and distinct protruding features 62, it should be understood that any shape of protruding features 62 can be formed through the use of appropriate programming instructions in CNC logic. For example, the CNC logic can be programmed with instructions to form application specific shapes, configurations and designs of the protruding features. In one example, the spacing between separate protruding features 62 may vary depending on the installation operating parameters. In one particular embodiment, the spacing distance or dimension between adjacent protruding features 62 is in a range from about 0.2″ to about 0.3″. In one particular embodiment, the spacing distance between the adjacent protruding features 62 is in a range from 0.25″ to 0.295″. In this example, it may be more advantageous to space the protruding features 62 farther apart, within the spacing distance range, in scenarios where the substrate 12 will be installed in regions where it is known to be icy, whereas it may be advantageous to space the protruding features 62 closer together in scenarios where the substrate 12 will be installed in regions where it is known to be wet with oil or water, or dusty/dirty. In one particular embodiment, the number of protruding features may be referenced by how many protruding features 62 are provided per linear foot. For example, one embodiment of the present disclosure provides twenty-eight protruding features 62 per linear foot.

In another example, the CNC logic may be encoded with instructions that form the protruding features in a specific design, such as a custom logo of a customer, rather than a simple grid/array. In another example, the instructions may be encoded to make only one single protruding feature that is formed as a continuous line (similar to a weld), regardless of whether it is curved or straight.

It has been determined that the use of powder material 70 being fed from three respective feed tubes 50A-50C and being energized with three respective energy beams 60A-60C has enabled system 10 of the present disclosure to utilize less powder material 70 than was previously required from using only a single radiation source and a single feed tube depositing powder material at the beam impingement point. Thus, the assembly of the present disclosure provides a more efficient use of powder material 70 without significantly increasing size, weight, or power over previous methodologies or instantiations. In one particular embodiment, the amount of powder material to create a protruding feature 62 having the same dimensions and volume as previously taught, is reduced by at least ten percent when utilizing three radiation sources 16A, 16B, and 16C and three independent powder sources 52A, 52B, and 52C. In other embodiments, the amount of powder material 70 that is reduced from previous teachings is at least 25 percent reduction in powder material 70. This savings or reduction in powder material 70 is due to the targeted deposition of powder material from at least three different locations that allow the sectors 64A, 64B, and 64C of the protruding feature 62 to be created and energized by respective beams 60A-60C. For example, if a protruding feature or 62 “bead” needs to have a width or diameter in a range from 0.04 to 0.12 inch and a bead height in a range from 0.015 to 0.065 inch, which would require an amount of powder material to create this resultant dimensions using the previous techniques, then system 10 of the present disclosure is able to create the same resultant dimensions with an amount of powder material 70 that is ten percent less than, or 90 percent of, that which was previously required. Other embodiments may provide a reduction of up to 25 percent less powder material.

In order to carry out the method of the present disclosure, the operating parameters of the energy or radiation sources 16 or each energy or radiation source 16A-16C are selected to yield the desired slip-resistant, non-slip, or protruding feature 62 configuration and a plurality of focused beams 60A-60C of radiation energy source, such as a laser, is projected at a select location on the substrate surface. Improving upon the known methods for depositing friction enhancing material on a substrate which require precise control of the energy beam, the present disclosure enables the energy beams 60A-60C to be delivered to the work surface or substrate 12 from a plurality of directions to produce a resultant non-slip feature on the work surface. In one particular example, it is delivered from three different directions, each beam within its own respective sector 64A-64C of a complete 360° circle. The present disclosure provides a plurality of energy beams 60A-60C having energy beam parameters and powder flow rate to control the slip-resistant or non-slip feature characteristics. These parameters include the selected positioning of the beams relative to the work surface, and the assembly or assemblies that effectuate the selected position of the beams. The selected non-skid powder blend particles are injected simultaneously with projecting the energy beam(s) on substrate or work surface. The particles are carried to a position proximate to the beam impingement point 58 through one or more feed tubes where the beam partially melts both the powder particles and a portion of the substrate material to form a bond between melted powder and the substrate material.

The present disclosure relies on higher power lasers, ranging between about 300 and about 10,000 watts depending on the selected substrate and powder materials. The higher powered energy beam enables the beam to reach the surface of the substrate by transforming powder particles in the beam path to a molten state which is then allowed to commingle with the molten material of the substrate at the impingement point thereby forming a localized fusion zone between the substrate material and the powder particles. The fusion zone extends into the thickness of the substrate beyond that typical of laser-cladding processes and may also encompass alloyed material slightly above the substrate surface. Whereas cladding generally limits material dilution, characterized as change in the powder material composition due to mixing of melted substrate material into the deposit, to less than ten percent, the present disclosure relies on some alloying of the deposit substrate materials to form a stronger bond between the non-slip feature and the substrate material or work surface. Cladding processes typically result in a shallow fusion zone depth on the order of 0.001-0.003 inches and therefore form significantly weaker bonds compared to the present method in which the depth of the material fusion zone ranges from 0.006 to 0.035 inches.

In one example, each of the radiation sources 16A-16C can be a high-power, industrial neodymium-doped yttrium aluminum garnet (YAG) or fiber laser having a power rating ranging between about 300 and about 10,000 watts. Each laser may be a pulsed YAG laser, a continuous YAG laser, or fiber laser that is capable of pulsed mode operation, meaning that it is capable of on/off cycles in the range of 5 to 65 milliseconds and that full power is developed in each on/off cycle. Each laser should have an output wavelength of 1.07×10−6 microns or less so that the desired energy is imparted to the substrate and powder particles. Longer wavelengths require greater laser power levels which can quickly exceed the power output capabilities of commercially economical or available lasers. An exemplary embodiment of the present disclosure uses a fiber laser having a wavelength of 1.07×10-6 microns and a nominal power of approximately 3,000 watts.

The work surface or substrate 12 can be formed of a metallic material, such as iron, carbon, alloy or stainless steel, aluminum, titanium, nickel, copper, and alloys thereof. The powder material 70 for forming the slip-resistant, raised, or protruding features 62 on the substrate surface 12 can be, but is not limited to low solubility, hard, irregularly shaped particles of nitride, carbide, boride, silicide, oxide, ceramic, aluminide, or mixtures thereof with a metallic metal or powder. The metallic metal or powder being one of, but not limited to, tungsten, stainless steel, carbon steel, aluminum, titanium, nickel, copper, their alloys, or mixtures thereof. The non-skid or powder material can be in the form of a powder, rod, slurry or any other form that allows the non-skid material to reach the point of impingement of energy beam(s) on the substrate surface. The powder particle size and size distribution is critical to the final size of the protruding feature 62. Variations in the powder material form may require alternative powder feeding mechanisms suitable for supplying the particular material form at the required rate for the process. It should be noted that the preceding is a non-limiting list of various materials that can be used in the present disclosure and other materials can also be used in making a substrate or an article with a slip-resistant or non-skid surface provided the selected powder material 70 results in a sufficiently rough or abrasive surface following the bonding process such that the desired surface coefficient of friction is achieved.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A system to generate a protruding feature on a surface, the system comprising:
a computer numerical code machine or assembly comprising a support surface defining a longitudinal direction, a transverse direction, and a vertical direction;
a moveable platform that is offset from the support surface, wherein the platform is moveable relative to the support surface in the longitudinal direction and in the transverse direction in response to instructions processed by the computer numerical code machine or assembly;
a plurality of radiation sources carried by the moveable platform, wherein each of the plurality of radiation sources generates an energy beam emitted from a radiation outlet, wherein the plurality of radiation sources comprises a first radiation source generating a first beam emitted through a first radiation outlet and a second radiation source generating a second beam emitted through a second radiation outlet;
a first powder material source; and
a first feed in particle-flow communication with the first powder material source to discharge first powder material fed from the first powder material source, wherein the first powder material is configured to be energized by the first beam that is adapted to result in a protruding feature being formed on a surface of a substrate.

2. They system of claim 1, further comprising:
a second powder material source;
a second feed in particle-flow communication with the second powder material source to discharge second powder material fed from the second powder material source, wherein the second powder material from the second power material source is configured to be energized by the second beam.

3. The system of claim 2, further comprising:
a third radiation source generating a third beam emitted through a third radiation outlet;
a third powder material source;
a third feed in particle-flow communication with the third powder material source to discharge third powder material fed from the third powder material source, wherein the third powder material from the third powder material source is configured to be energized by the third beam.

4. The system of claim 3, further comprising:
a center axis;
a first sector bound by a first central angle of 120° relative to the center axis;
a second sector bound by a second central angle of 120° relative to the center axis;
a third sector bound by a third central angle of 120° relative to the center axis.

5. The system of claim 4, further comprising:
wherein the first powder material from the first powder material source is deposited into the first sector after exiting the first feed;
wherein the second powder material from the second powder material source is deposited into the second sector after exiting the second feed; and
wherein the third powder material from the third powder material source is deposited into the third sector after exiting the third feed.

6. The system of claim 3, further comprising:
a center axis of the moveable platform;
wherein the first radiation outlet, second radiation outlet, and third radiation outlet are evenly spaced 120° from each other around to the center axis.

7. The system of claim 3, further comprising:
a center axis;
a first axis extending centrally through the first radiation source; and
a first angle defined between the center axis and the first axis of the first radiation source, wherein the first angle is greater than 10°.

8. The system of claim 7, further comprising:
a second axis extending centrally through the second radiation source; and
a second angle defined between the center axis and the second axis of the second radiation source, wherein the second angle is greater than 10°.

9. The system of claim 8, further comprising:
a third axis extending centrally through the third radiation source; and
a third angle defined between the center axis and the third axis of the third radiation source, wherein the third angle is greater than 10°.

10. The system of claim 9, further comprising:
wherein the first angle is in range from about 15° to about 450;
wherein the second angle is in range from about 15° to about 450; and
wherein the third angle is in range from about 15° to about 45°.

11. The system of claim 3, wherein each radiation outlet of the plurality of radiation sources is moveable in conjunction with the moveable platform.

12. The system of claim 1, further comprising:
a substrate having first and second ends aligned in the longitudinal direction, and having first and second sides aligned in the transverse direction, and having a first surface and a second surface aligned in the vertical therebetween, wherein the protruding feature is formed on the first surface of the substrate to create one of a plurality of protruding features that collectively form a designed configuration of non-slip elements on the substrate.

13. A method comprising:
depositing powder material at a beam impingement point on a surface of a substrate;
activating a plurality of radiation sources;
generating at least one beam of radiation at each of the plurality of radiation sources;
radiating at least one beam outward from each radiation source, wherein the at least one beam is part of a plurality of radiation beams;
directing the plurality of radiation beams towards the beam impingement point on the substrate, wherein the plurality of radiation beams energize the powder material;
liquefying the powder material at the beam impingement point with the plurality of radiation beams;
ceasing the radiating of the plurality of radiation beams; and
allowing the liquefied powder material to cool to form a protruding feature on the substrate.

14. The method of claim 13, further comprising:
determining, via input, a presence of the substrate on a support surface of a computer numerical code machine or assembly;
moving a platform that carries the plurality of radiation sources in at least one of a longitudinal direction and transverse direction; and
determining a bounded region of the substrate within which the protruding features will be formed.

15. The method of claim 14, further comprising:
subsequent to the protruding feature having been formed, moving the platform that carries the plurality of radiation sources in at least one of a longitudinal direction and transverse direction to a second location relative to the substrate;
forming a second protruding feature.

16. The method of claim 13, further comprising:
metering powder material through a plurality of feeds, each feed in particle-flow communication with a powder material source.

17. The method of claim 13, further comprising:
generating a first radiation beam and directing the first radiation beam to a first sector bound by a first central angle of 120° relative to a center axis extending vertically through the beam impingement point;
generating a second radiation beam and directing the second radiation beam to a second sector bound by a second central angle of 120° relative to the center axis; and
generating a third radiation beam and directing the third radiation beam to a third sector bound by a third central angle of 120° relative to the center axis.

18. The method of claim 13, further comprising:
orienting a first radiation source along a first axis; and
defining a first angle between a vertical center axis and the first axis of the first radiation source, wherein the first angle is greater than 10°.

19. At least one computer readable non-transitory computer readable storage medium having instructions encoded thereon that, when executed by a processor, implement operations to form a protruding feature on a surface of a substrate, the instructions including:
deposit powder material at a beam impingement point on the surface of the substrate;
activate a plurality of radiation sources;
generate at least one beam of radiation at each of the plurality of radiation sources;
radiate at least one beam outward from each radiation source, wherein the at least one beam is part of a plurality of radiation beams;
direct the plurality of radiation beams towards the beam impingement point on the substrate, wherein the plurality of radiation beams are operable to energize the powder material;
confirm that the powder material at the beam impingement point with the plurality of radiation beams has been liquefied;
cease the radiating of the plurality of radiation beams after the powder material has liquefied; and
effect the liquefied powder material to cool to form the protruding feature on the substrate.
